(19) United States
(12) Patent Application Publication
(10) Pub. No.: US 2017/0004845 A1
(43) Pub. Date: Jan. 5, 2017

(54) HANDHELD DEVICE WITH MICROPHONE

(71) Applicant: TP VISION HOLDING B.V., Amsterdam (NL)

(72) Inventor: Jeroen Daniel Annick VERHAEGHE, Ghent (BE)

(73) Assignee: TP Vision Holding B.V., Amsterdam (NL)

(21) Appl. No.: 15/107,440

(22) PCT Filed: Feb. 2, 2015
(86) PCT No.: PCT/EP2015/052058

§ 371 Date: Jun. 22, 2016

(30) Foreign Application Priority Data
Feb. 4, 2014 (EP) 14153734.0

(51) Int. Cl. G10L 21/034; G10L 15/22; G10L 25/51

(52) U.S. Cl. CPC G10L 21/034; G10L 25/51; G10L 15/22

(57) ABSTRACT

A handheld device comprises a microphone (12) for converting speech into an audio signal. The device also comprises an audio signal amplifier (13) for amplifying the audio signal, and means (14) for adjusting the gain of the audio signal amplifier. The device further comprises means (15) for determining an orientation of the device with respect to a horizontal plane. The device is configured to adjust the gain of the audio signal amplifier in a dependence on the determined orientation of the device. The device is further configured to adjust the gain of the audio amplifier to a first value when the device is oriented essentially horizontal and to a second value when the device is oriented essentially vertical, the first value being higher than the second value.

### FIELD OF THE INVENTION

The present invention relates to handheld devices equipped with a microphone.

### BACKGROUND OF THE INVENTION

Many electronic consumer devices, such as flat televisions, set-top boxes, Blu-ray players or home theatre systems, are operated using a handheld remote control. In recent years voice control has been introduced in such devices, usually as an additional way of controlling the device. In such cases commonly the remote control has a microphone built in for receiving the commands spoken by the user, which are interpreted using well-known speech recognition technology.

The distance between the microphone and the user's mouth may vary quite a lot, from a few centimetres when held close to the mouth to more than half a meter when held at arm's length. This greatly affects the sound level received by the microphone, and the gain of the microphone amplifier needs to be adjusted accordingly. Unfortunately, automatic gain control cannot always be applied. For example, when a command consists of just a short word, adjusting the gain halfway the word will interfere with the speech recognition and hamper the correct recognition of the command.

A similar problem occurs in other handheld devices, such as for example smart phones, where speech is received for control as well as for communication purposes.

US 2013/0202130 A1 describes a hand held device equipped with a sensor system for measuring the distance to the user's head by using infrared, acoustic or photographic sensors. The measured distance is used to adjust the microphone amplifier gain.

US 2011/0158425 A1 describes a cellular phone that adjusts the directivity of its two microphones based on acquired sound source direction information if the acquired sound source direction information is determined to be correct and based on a determined tilt angle and a previously learned mapping from tilt angle to sound source direction information otherwise. US 2011/0158425 A1 further describes the cellular phone including a microphone gain controller for adjusting the gain of amplification of a sound signal input from the microphones based on the sound source direction information.

These solutions are not always practical in consumer electronics devices such as remote controls or other hand held devices, and they are also expensive.

### SUMMARY OF THE INVENTION

It is an object of the invention to offer an improved alternative solution for adjusting the microphone gain in a hand held device.

This is achieved, according to a first aspect of the invention, by a handheld device comprising a microphone for converting speech into an audio signal, an audio signal amplifier for amplifying the audio signal, means for adjusting the gain of the audio signal amplifier, and means for determining an orientation of the device with respect to a horizontal plane, characterized in that the device is configured to adjust the gain of the audio signal amplifier in a dependence on the determined orientation of the device, the device being configured to adjust the gain of the audio amplifier to a first value when the device is oriented essentially horizontal and to a second value when the device is oriented essentially vertical, the first value being higher than the second value. The invention is, inter alia, based on the insight that for handheld devices the orientation of the device is a good indicator for the distance between the device and the user's mouth. This enables the correct setting of the microphone gain without actually measuring this distance, which can be realized in a technically simple manner.

Detecting whether a device is oriented essentially horizontal or vertical is known from US2011/0191108, which describes activating a voice search by tilting the remote into an upright position like a hand held microphone.

In an embodiment of the invention, the device is configured to adjust the gain of the audio signal amplifier such that the gain increases with an increasing angle of device with respect to the horizontal plane. In a further embodiment the highest gain value corresponds to an essentially vertical orientation of the device. And in a further embodiment the lowest gain value corresponds to an essentially horizontal orientation of the device. These are all based on the insight that a vertical orientation corresponds in practice to the closest distance between the device and the user's mount, whereas a horizontal orientation corresponds to the largest distance in practical use.

In a further embodiment of the invention, the device comprises means for determining the strength of the audio signal, and is configured to determine the dependence based on the determined orientation and a determined signal strength. In a further embodiment the dependence is determined by comparing tilt values with audio signal strength during use of the device. These embodiments have the advantage that the device can ‘learn’ the relation between orientation and distance in practice, adapted to a particular user.

### BRIEF DESCRIPTION OF THE DRAWINGS

Further embodiments of the device according to the invention and the advantages thereof will be apparent from and elucidated further with reference to the accompanying drawings, in which

FIG. 1 shows a user holding a remote control;

FIG. 2 shows a user holding a remote control;

FIG. 3 shows a system diagram;

FIG. 4 shows a system diagram.

### DETAILED DESCRIPTION OF EMBODIMENTS

The following description focusses mainly on embodiments of the invention applied in remote control of a consumer electronics device with voice control functionality, by way of example. However, it must be appreciated that the invention is not limited to such remote controls only, but may be applied in other handheld consumer devices that receive sound input, such as tablets or mobile phones. Also the invention is not limited to the functionality of voice control, the sound input may also be used for other purposes, such as communication.

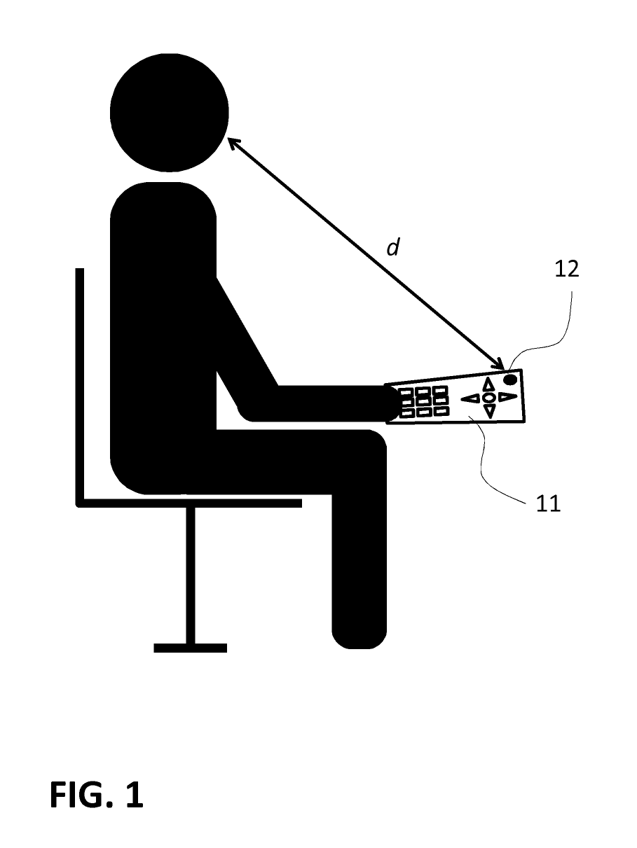

FIG. 1 shows a user holding a remote control 11 to control a device, such as a flat television. The remote control 11 is equipped with a microphone 12 for converting sound into an audio signal. Note that the user will normally hold the remote control 11 with the buttons facing upward, here they are shown just for clarity of the illustration. The microphone 12 may be used for receiving speech input to operate the flat television with voice control, or it may be used to capture the user's voice for communication purposes like video chatting, or for yet some other purpose. The distance d between the microphone 12 and the user's mouth is indicated with an arrow, and may in this situation for example be around 60 cm.

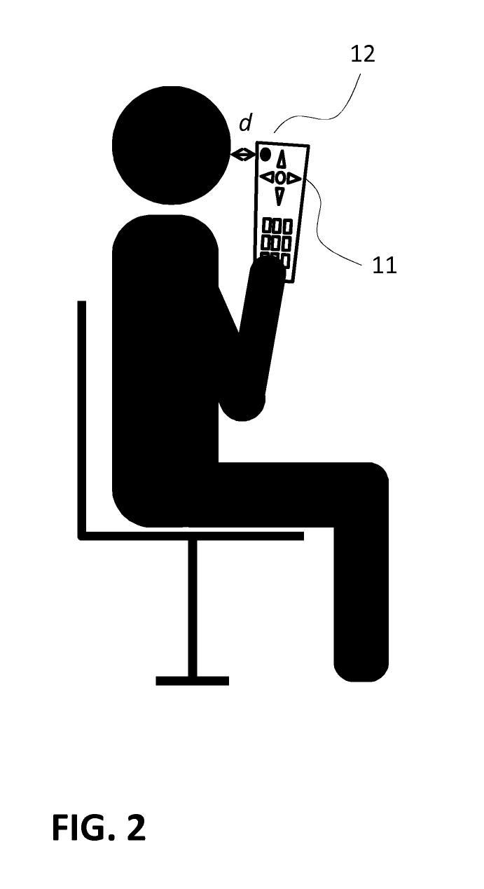

FIG. 2 show the same user, now holding the same remote control 11 close to his head. The distance d between mouth and microphone 12 may now be only 5-10 cm.

The difference in distance between the two situations means that the sound intensity received by the microphone 12 may differ two orders of magnitude due to the quadratic decay of sound intensity with distance. To handle both situations correctly some form of gain control will be needed to prevent clipping or too low levels in the audio signal. Automatic gain control cannot always be applied, however. In case speech is received for voice control, changing the gain during a command spoken by the user my interfere with the correct recognition of the command. Also, means for automatic gain control may not be present in the remote control device.

If the distance d between mouth and microphone 12 could be measured, the result could be used to set a proper gain depending on the distance. This will work well in practice, but the means needed to perform the measurement are not commonly present in handheld devices, and too expensive to add just for this function.

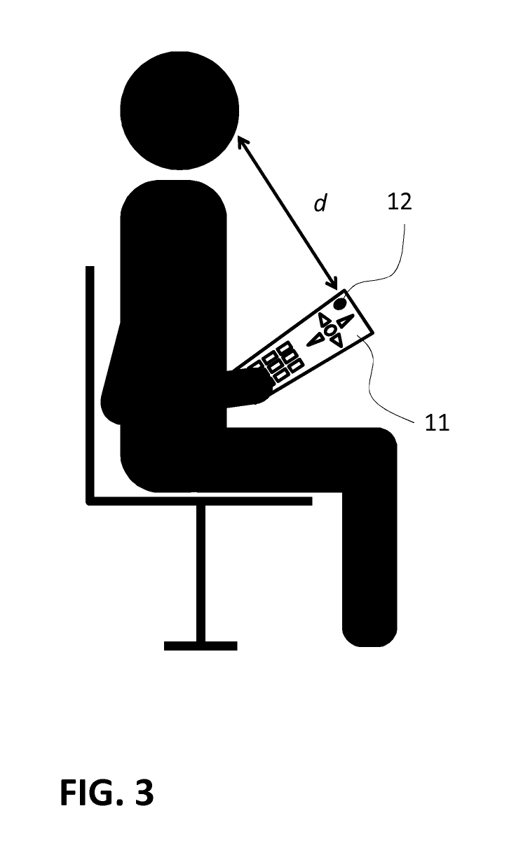

The inventors have realised that it is possible to distinguish between the situations of FIGS. 1 and 2 by detecting the orientation of the remote control 11. In the first situation with the remote control 11 held on the knees, the remote control 11 is held in a horizontal orientation, whereas in the second situation with the remote control 11 held close to the mouth, it is held in a vertical orientation. Thus a horizontal orientation of the handheld device points to a longer distance between mouth and microphone 12 and the need for a higher gain, whereas a vertical orientation points to a short distance and the need for a lower gain value. This relation has been found to work well in practice. Indeed, in an intermediate situation as shown in FIG. 3, the remote control is held at an angle of about 45° from horizontal when held on the lap close to the body, and in this case the distance as well as the orientation are in between the horizontal and vertical situations. Thus the orientation of the remote control with respect to the horizontal plane, the tilt, may be used to determine the appropriate gain value for the microphone amplifier to be used.

Increasingly, modern remote controls may also include pointing technology, by which the user can control, for example, a pointer or indicator on a television screen by moving the remote control. This functionality is commonly enabled by accelerometers, gyroscopic or other sensors in the remote control, which have become quite common with the advent of microelectromechanical systems (MEMS) technology.

The inventors have realised that the sensors used for the pointing functionality can be used to determine the tilt of the remote control. Such sensors commonly can detect the direction of gravity, so they can be used to determine the tilt of the remote control. Even if types of sensors are used that can only detect relative tilt, the absolute tilt may still be determined after some form of calibration. In case of a remote control this can be done while the remote control is in a known position which is associated with a predetermined orientation, for example lying on a table where it spends most of its time and wherein the device has a horizontal orientation. If the remote control has some form of charging station, which is common for devices with pointing functionality, the orientation of the device when it is placed in the charging device will be known and fixed, and can be used to calibrate the absolute tilt.

In a first basic approach, the tilt of the remote control device is measured using the sensors, and the gain for the microphone amplifier is determined based on the tilt value. There may be a simple linear or other predetermined relation between tilt value and gain value, or a lookup table (LUT) may be used in which the appropriate gain value for certain tilt values is fixed, and intermediate values may be derived with interpolation.

Alternatively, the device may self-learn the relation between required gain value and tilt value during use. By relating tilt values with audio signal strength a relationship between appropriate gain value and tilt can be established, which is in that case implicitly adjusted to the user with regard to for example loudness of voice, ways of holding the remote control, or length of arms. This self-learning may continuously occur during regular usage of the remote control, or there may be a calibration procedure in which the user is asked to give a number of commands holding the remote control in various ways.

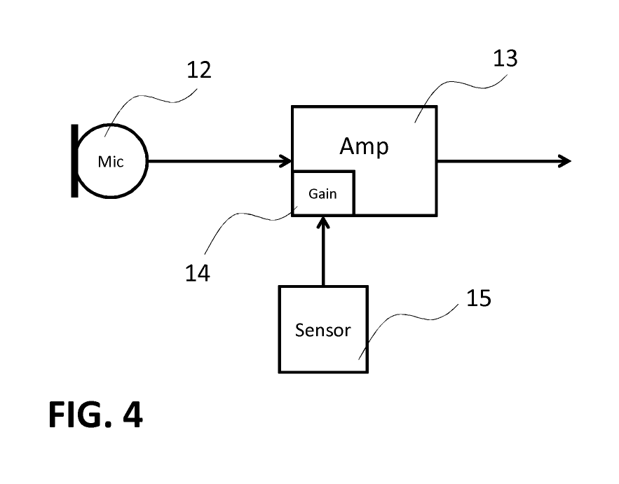

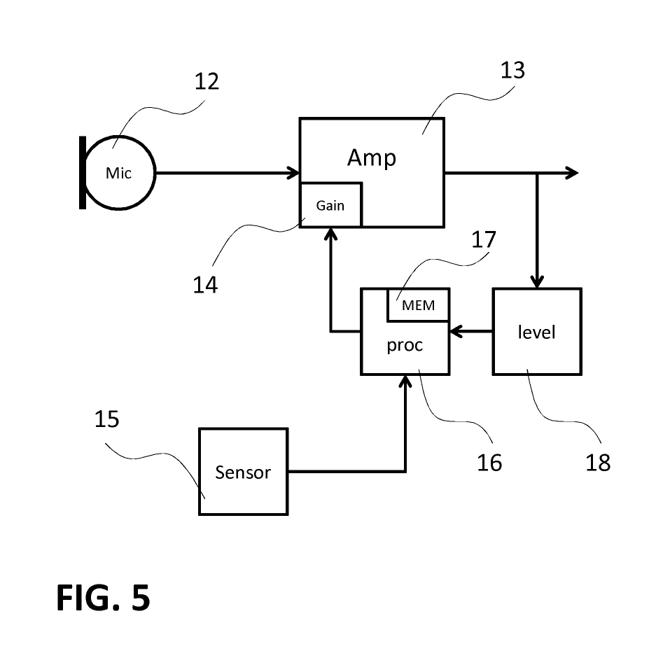

FIG. 4 presents a simple system diagram showing the main parts required to implement the invention. The microphone 12 is connected to an audio signal amplifier 13 which has an input 14 for setting the gain value. To this input is connected the output of the tilt sensor 15.

FIG. 5 presents a somewhat more advanced implementation, where a micro-processor 16 is added, with memory 17. This processor receives tilt values from the sensor, and receives audio signal strength information from the circuit 18, arranged to determine the audio signal strength from the amplifier output. Based on the tilt value, the processor may select the appropriate gain value from a lookup table stored in the memory, or calculate it using parameters stored in memory. The processor is connected to the gain input 14 of the audio signal amplifier 13 to set the appropriate gain in response to the tilt value. In a self-learning configuration the processor will monitor the audio levels measured by circuit 18 and the tilt values measure by the sensor 15, and use it to determine a relation between tilt and required gain value which may be stored in memory as a lookup table or as parameters to a function.

Although several embodiments of the present invention have been illustrated in the accompanying drawings and described in the above detailed description, it will be understood that the invention is not limited to the embodiments disclosed, but is capable of numerous modifications without departing from the scope of the invention as set out in the following claims.

1. A handheld device comprising a microphone (12) for converting speech into an audio signal, an audio signal amplifier (13) for amplifying the audio signal, means (14) for adjusting the gain of the audio signal amplifier; and
means (15) for determining an orientation of the device with respect to a horizontal plane,
characterized in that the device is configured to adjust the gain of the audio signal amplifier in a dependence on the determined orientation of the device, the device being configured to adjust the gain of the audio amplifier to a first value when the device is oriented essentially horizontal and to a second value when the device is oriented essentially vertical, the first value being higher than the second value.

2. A handheld device as described in claim 1, configured to adjust the gain of the audio signal amplifier (13) such that the gain decreases with an increasing angle of the device with respect to the horizontal plane.

3. A handheld device as described in claim 1, configured to adjust the gain of the audio signal amplifier (13) such that the highest gain value corresponds to an essentially horizontal orientation of the device.

4. A handheld device as described in claim 1, configured to adjust the gain of the audio signal amplifier (13) such that the lowest gain value corresponds to an essentially vertical orientation of the device.

5. A handheld device as described in one of the previous claims, comprising means (15) for calibrating the means for determining the orientation in response to a determination that the device is in a known position associated with a predetermined orientation.

6. A handheld device as described in one of the previous claims, configured to translate the audio signal into a command using speech recognition.

7. A handheld device as described in one of the previous claims comprising means (18) for determining the strength of the audio signal, and configured to determine the dependence based on the determined orientation and the determined signal strength.

8. A handheld device as described in one of the previous claims, where the device is a remote control device.

9. A handheld device as described in claim 8, where the device is a pointing remote control device.
